(19) United States
(12) Patent Application Publication
(10) Pub. No.: US 2026/0360108 A1
(43) Pub. Date: Nov. 12, 2026

(54) METHOD AND SYSTEM FOR AI-POWERED COMPLIANCE DETERMINATION

(71) Applicant: Unefi Inc., Toronto (CA)

(72) Inventors: Ranko DIMIC, Toronto (CA); Samuel Arthur VISE, Toronto (CA); Tibor SZANTO, Toronto (CA)

(73) Assignee: Unefi Inc., Toronto, ON (CA)

(21) Appl. No.: 19/515,077

(22) PCT Filed: Nov. 28, 2024
(86) PCT No.: PCT/CA2024/051586

§ 371 Date: Feb. 27, 2026

Related U.S. Application Data
(60) Provisional application No. 63/603,745, filed on Nov. 29, 2023.

(51) Int. Cl. G06V 10/75; G06Q 30/018; G06V 10/26; G06V 10/774

(52) U.S. Cl. CPC G06V 10/751; G06Q 30/018; G06V 10/26; G06V 10/774

(57) ABSTRACT

Systems and methods for automatic determination whether a configured display fixture conforms to an expected configuration. An image of the configured display fixture is received from a confirmation user and this image is processed by a recognition module that recognizes elements in the image by way of either a computer readable code on the image or by way of an AI-based image recognition process. The recognized elements in the image are automatically compared with the expected configuration. If all the elements in the expected configuration are present in the recognized elements, then the configured display fixture conforms to the expected configuration. If elements are missing or if elements are not recognized, these unrecognized/missing elements are highlighted/listed. The system also allows for a user to confirm/accept or to reject the results of the comparison between the recognized elements and the expected configuration.

### TECHNICAL FIELD

The present invention relates to tangible display fixtures at retail locations. More specifically, the present invention relates to systems and methods for checking a tangible display fixture for conformity with an expected configuration.

### BACKGROUND

Product display management and keeping track of what products and marketing materials are on display and where these are supposed to be placed can be a time consuming and difficult task, especially for large organizations with many stores. Such large organizations require that their displays be uniform across multiple locations and ensuring that uniformity can be challenging.

Some organizations use systems that enable store managers to check each display against a head office mandated configuration to thereby ensure that each display conforms to that configuration. This can, of course, be done manually but, as can be imagined, this can take quite a bit of time and effort on the part of those who have to manage each store's displays.

One issue with current systems is that some items that have little visual variations across brands, such that determining which item is on display can be a time consuming and annoying task for such managers. For example, most smartphones look very much alike across different brands and models-they are a simply black slabs with a glass display screen and, other than a close inspection of the outside and/or a detailed look at the device when operating, it can be difficult to determine which item is which. The same could be said for notebooks, tablets, and other electronic devices.

The management of such displays, especially when changes need to be performed on the display, can be an issue. Once changes have been made to the display, does the new display still conform to the expected/desired configuration? Are the correct items being displayed? Are the correct marketing videos/demonstration videos being displayed on the video displays in the store? Absent a detailed (and manual) review of each tangible display fixture and each and every item on the display fixture, this task cannot be performed quickly and efficiently using current systems.

There is therefore a need for systems and methods that allow for not just easy identification of devices on display on a shelf but for a quick and easy check of each display's conformity with a deserved configuration. Preferably, such systems and methods are integratable with product display management systems.

### SUMMARY

The present invention provides systems and methods relating to automatic determination if a configured display fixture conforms to an expected configuration. An image of the configured display fixture is received from a confirmation user and this image is processed by a recognition module that recognizes elements in the image by way of either a computer readable code on the image or by way of an AI-based image recognition process. The recognized elements in the image are then automatically compared with the expected configuration. If all the elements in the expected configuration are present in the recognized elements, then the configured display fixture conforms to the expected configuration. If there are elements missing or if elements are not recognized, these unrecognized elements are highlighted to the user or the missing elements are listed. The system also allows for a user to confirm/accept or to reject the results of the comparison between the recognized elements and the expected configuration.

In a first aspect, the present invention provides a system for checking a tangible display fixture for conformity with an expected configuration, the system comprising:
a checking module for receiving an image of said tangible display fixture from a user and for determining whether said tangible display fixture conforms with said expected configuration based on a comparison of elements of said image with said expected configuration;
a database for storing said image of said tangible display fixture, for storing said expected configuration of said tangible display fixture, and for storing results of said comparison of elements
a recognition module for receiving a version of said image and for recognizing one or more of said plurality of elements in said image by way of an image recognition process or by way of one or more computer readable codes contained in said image;
wherein said recognition module retrieves said expected configuration from said database and said checking module compares said expected configuration with recognized elements in said image.

In a second aspect, the present invention provides a method for determining if a tangible display fixture conforms with an expected configuration, the method comprising:
a) receiving an image of a configured tangible display fixture;
b) recognizing one or more elements in said image;
c) identifying said one or more elements recognized in step b);
d) retrieving identification data for said one or more elements recognized in step b);
e) comparing said one or more elements recognized in step b) with an expected configuration for said configured tangible display fixture;
f) determining whether said configured tangible display fixture conforms with said expected configuration based on results of step e);
wherein step c) is executed using an AI-based image recognition process or by way of one or more computer readable codes contained in said image.

In another aspect, the system of the present invention includes an acceptance module for presenting an administrative user with the image of the tangible display fixture and the results of the comparison of elements. The acceptance module receives input from the administrative user that either accepts the results or rejects the results.

Additionally, the system of the present invention may include a learning module for receiving images of elements to be recognized by the system, the images of element being for use in training a machine learning model used by the image recognition process.

In yet another aspect, the system of the present invention includes a synthetic image module for applying image alteration techniques to one or more of the images of elements to be recognized by the system. This produces synthetic images of the elements to be recognized, these synthetic images being for use in training the machine learning model.

In a further aspect, the system also includes a segmenting module for receiving the image from the checking module and for segmenting the image into a segmented image that divides the image into a plurality of elements.

It should be noted that, in yet a further aspect, the recognition module produces a list of elements recognized in the image and the expected configuration is a list of expected elements in said image. This list of expected elements is compared with the list of elements recognized in the image. Based on the list of elements recognized in the image, the comparison results produce an indication that the tangible display fixture conforms with the expected configuration when all elements in the list of expected elements are recognized in the image.

In one configuration, based on the list of elements recognized in the image, the results of the comparison produce a detailing of any elements that are missing from the image but which are present in the list of expected elements.

### BRIEF DESCRIPTION OF THE DRAWINGS

The embodiments of the present invention will now be described by reference to the following figures, in which identical reference numerals in different figures indicate identical elements and in which:

FIG. 1A is a block diagram of a system according to one aspect of the present invention;

FIG. 1B is a block diagram of a variant of the system illustrated in FIG. 1A;

FIG. 2 is a block diagram of another aspect of the present invention where the system in FIG. 2 is for user confirmation and/or amendment of comparison results between an expected configuration and a resulting configuration;

FIG. 3 is an example image provided to the system by way of a user device of a confirmation user;

FIG. 4 is an example image of the expected configuration with markings detailing which elements have not been recognized/identified;

FIG. 5 is a screenshot of options available to a confirmation user in the event an element is unrecognized/unidentified by the system;

FIG. 6 illustrates a rendering of an expected configuration of a tangible display fixture where overridden elements are marked with a striped dot;

FIG. 7 is a listing of expected elements in the configured tangible display fixture;

FIG. 8 is an example image received from the confirmation user by the system and is provided to detail a comparison with the image in FIG. 6;

FIG. 9A is a view of an element that was overridden by the confirmation user with all other elements removed;

FIG. 9B shows the overrides implemented by the confirming user;

FIG. 10 is a screenshot of a list of missing/unverified elements;

FIG. 11 is a screenshot of an expected element in the configured tangible display fixture;

FIG. 12 is a screenshot of an actual configuration of the configured tangible display fixture; and

FIG. 13 illustrates grouped images for use in training a model used by the image recognition module that is part of the system illustrated in FIG. 1A.

### DETAILED DESCRIPTION

In one aspect of the present invention, there is provided a system for receiving an image of a configured tangible display fixture and for assessing whether that tangible display fixture conforms to an expected configuration. A checking module receives the image from a confirmation user device and sends the received image to a recognition module that examines the image. The image is reviewed and, using either using an AI based image recognition process or by way of a computer readable code contained in the image, items or elements are recognized in the image. A list of the identities of the identified elements is assembled and this list is automatically compared with a list of expected elements for the tangible display fixture. The list of expected elements is the expected configuration for the tangible display fixture. Differences between these two lists can then be provided to the user for further action. The system can be incorporated into a larger system that manages multiple tangible display fixtures and which can be used to prompt users to implement changes to a tangible display fixture. Once the changes have been implemented, the system of the present invention can be used to determine if the changes have been implemented properly.

In one variant, the image is first sent to a segmenting module. The segmenting module segments the image into segments, each segment containing an element such as a product, a retail item, or an advertising display. Each segment is then assessed by the image recognition module to determine if the segment is a recognized segment. Recognized segments are then identified and their identities are retrieved from a database and the identities are used to construct.

In another aspect, the present invention also provides for a system that allows an administrative user to review the images received by the system and the results of the comparison of the two lists noted above. This system also allows the administrative user to review the results of the comparison after a comparison user has edited the results. The administrative user is provided with the results along with the image or images from the comparison user. The administrative user can then confirm, override, reject, or correct the results in light of the images from the confirmation user.

It should be clear that differences between the two lists noted above can be indicated as an overlay over the images received from the user and that differences between the two lists can cause the system to prompt the confirmation user to correct the differences, override any detected differences, or to let the differences remain. As noted above, any edited results (i.e., edited by actions such as corrections or overrides) can be reviewed and/or corrected/confirmed/rejected by the administrative user.

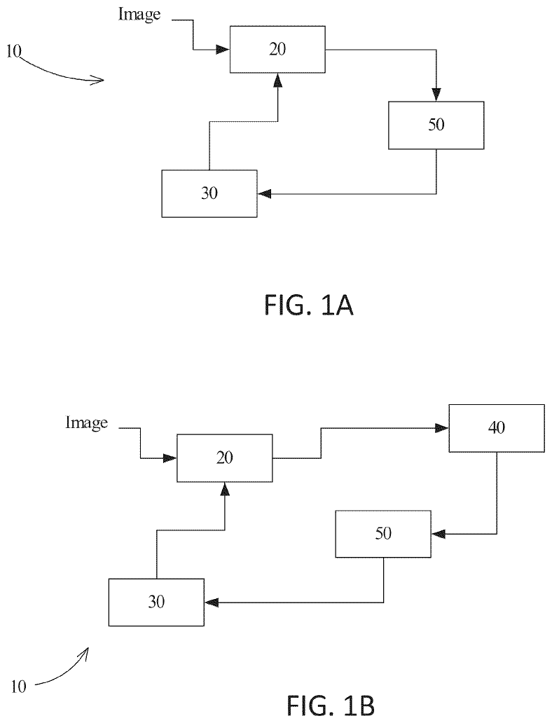

Referring to FIG. 1A, a block diagram of a system according to one aspect of the present invention is illustrated. As can be seen, the system 10 includes a checking module 20, a database 30, and a recognition module 50. In operation, the checking module 20 receives an image of a configured tangible display fixture. This image is then sent to the recognition module to recognize/identify the elements in the image. The recognition module first applies a process to detect computer readable codes (e.g. QR codes) in the image. Once these codes are detected, then the codes are read. Each code identifies an element and the relevant identification data for the item that is the identified element is retrieved from the database 30. Alternatively, if a code is not detected, an AI based image recognition process is applied to recognize the elements/items in the image. Each recognized item is then identified and the relevant identification data for that item is retrieved from the database. The identification data for the recognized items are then collated into a list. A list of expected elements on the tangible display fixture is then retrieved from the database and the two lists are compared.

Discrepancies between the two lists can be provided to a user and the user can adjust/edit/override such discrepancies. Items not found in the recognized items list but which are in the expected elements list are denoted as not found or not recognized in the image.

Referring to FIG. 1B, a variant of the system in FIG. 1A is illustrated. As can be seen, the system 10 includes a checking module 20, a database 30, a segmenting module 40, and a recognition module 50. In operation, the checking module 20 receives an image of a configured tangible display fixture. The image is then sent to the segmenting module and the image is divided into its various elements by segmentation. Each segmented element is then, in turn, sent to the recognition module. Each segmented element is processed by the recognition module. For each element, the recognition module first applies a process to detect computer readable codes in the (e.g. QR codes) segmented element. Once a code is detected, then the code is read. The code identifies the element and the relevant identification data for the item in the identified element is retrieved from the database 30. Alternatively, if a code is not detected, an AI based image recognition process is applied to recognize the element/item in the segment. A recognized item is then identified and the relevant identification data for that item is retrieved from the database. After all the segments are processed, then the identification data for the recognized items are collated into a list. A list of expected elements on the tangible display fixture is then retrieved from the database and the two lists are compared. Discrepancies between the two lists can be provided to a user and the user can adjust/edit/override such discrepancies. Items not found in the recognized items list but which are in the expected elements list are denoted as not found or not recognized in the image.

Note that, when processing each segment, if an item is not recognized and or there is no code for an item, an error code or indication that recognition has failed is returned.

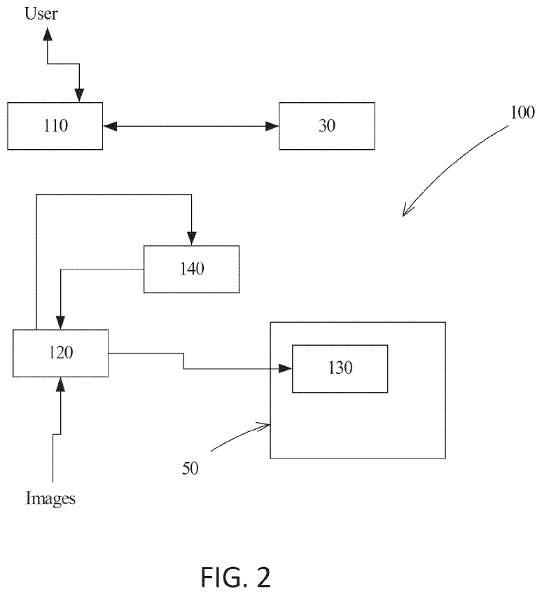

Referring to FIG. 2, a block diagram of another aspect of the present invention is illustrated. As can be seen from FIG. 2, a system 100 provides for user confirmation and/or amendment of the results of the comparison of the lists detailed above. For clarity, once a confirmation user has confirmed/edited/overridden the results of the comparison for the system in FIG. 1, these results are stored in the database along with the image uploaded by the confirmation user. After being stored in the database, an administrative user can review the results as confirmed and/or edited by the confirmation user in light of the image uploaded by the confirmation user.

The system 100 in FIG. 2 includes the database 30 and an acceptance module 110. The administrative user uses the acceptance module 110 to retrieve the stored results of comparison between the two lists noted above for a specific tangible display fixture. The results, along with the image uploaded by the confirmation user, are provided to the administrative user. The administrative user can then confirm, override, or correct the results based on the provided results and the image. These results, after being confirmed, overridden, or corrected by the administrative user can then be stored again with the image.

As can be seen in FIG. 2, the system may include a learning module 120. The learning module 120 receives images of elements that the machine learning model is to be trained to recognize in the images received from the confirmation user. For clarity, the recognition module 50 uses a trained model 130 that recognizes the various elements in a configured tangible display fixture. The learning module 120 can receive multiple versions/sizes of images of an element that the model is to be trained to recognize. These images can also be sent to a synthetic image module 140 that produces generated images by applying image alteration techniques to the images. The synthetic image module 140 thus generates more images of the same element. Such generated images can form a synthetic data set that can be used to further train the model (by way of the learning module) to recognize the same element. These image alteration techniques can be applied to the images by the synthetic image module to generate the synthetic data set. Of course, after the multiple images of the element have been used to train the model, the identification (as well as any necessary details) for that element is stored in the database.

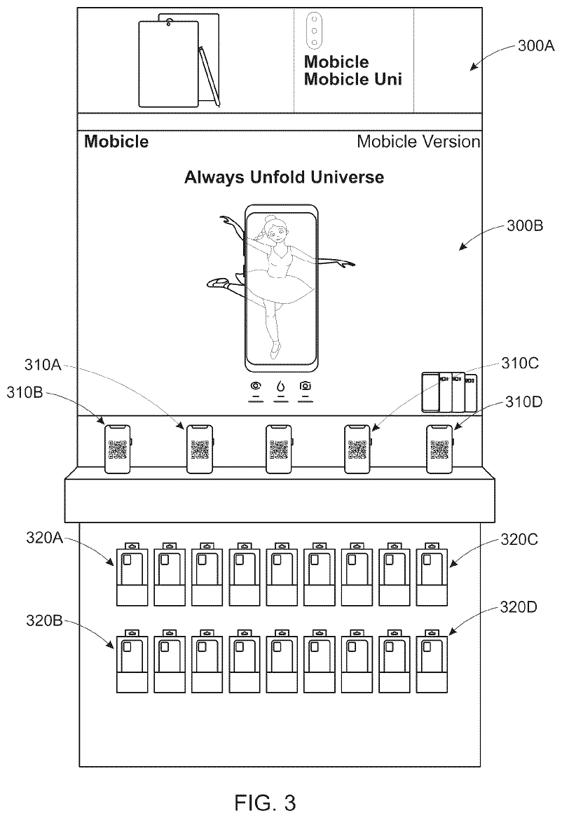

Referring to FIG. 3, illustrated is an example image provided to the system by a user device from a confirmation user. The image is that of a configured tangible display fixture and is provided to the system to determine if the fixture conforms to an expected configuration. As can be seen, the image shows advertising displays 300A, 300B, a number of first mobile telephone handsets 310A, 310B, 310C, 310D, 310E with each of the handsets displaying a computer readable code (in this case a QR code). Also in the image are a number of mobile telephone handset cases 320A, 320B, 320C, 320D.

In operation, the image in FIG. 3 is processed by the system. In the version that includes the segmenting module, the various handsets are segmented into their own segments while each advertising display is also divided into its own segment. Similarly, each handset case is also provided in its own segment. Each of these segments is processed by the image recognition module. As noted above, QR codes (or similar codes) are recognized by the image recognition module and the identification data for the items with the recognized codes are retrieved. For the elements that do not have QR codes, the AI image recognition process is used to identify the element. As part of the AI image recognition process, the text in the advertising displays can be used to recognize the displays.

For the system that does not use a segmenting module, the image as a whole is processed. The image is scanned for computer readable codes (e.g. QR codes) and these are read and identified. As well, the image is scanned for items that correspond to elements that are known/learned by the system. For this, portions of elements, including text or specific parts of images, may be used to recognize/identify elements in the image. As an example, the text in the displays 300A, 300B can be used to correlate the displays 300A, 300B as known/recognized elements. Similarly, the image of the dancer and the handset can be used to identify the display.

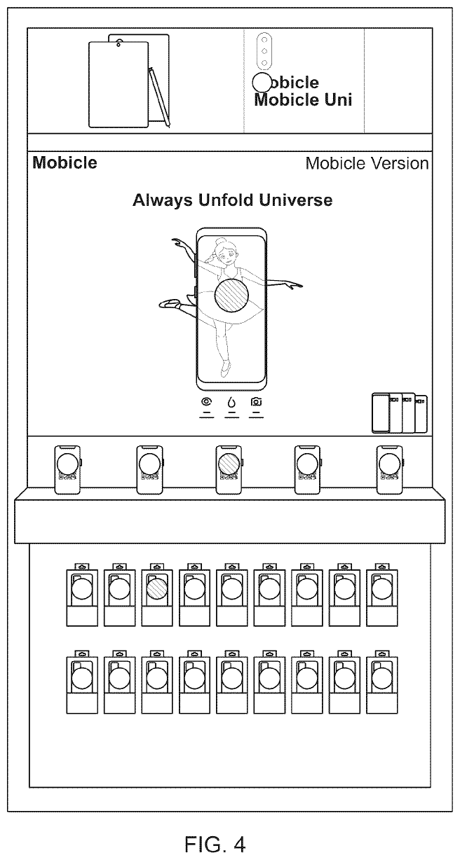

Regardless of the version of the system used to process the image, the result may be that illustrated in FIG. 4. As can be seen in FIG. 4, the identified elements are marked with a blank/white dot while the unrecognized/unidentified elements are marked with a striped dot. For clarity, identified elements may be marked with blank/white dots while unrecognized/unidentified elements are marked with striped dots.

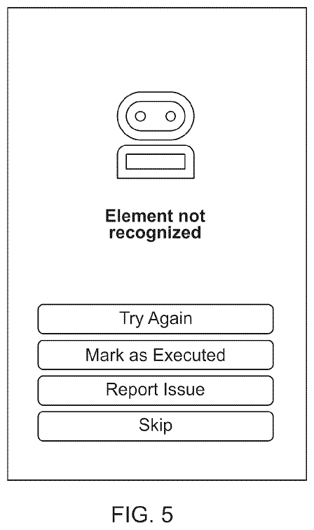

For the unrecognized items, the system may isolate the elements not recognized and may prompt the user to take another image of that element. As a guide for the user, an overlay of the unidentified item may be provided so that the user can align the overlay with the expected image prior to the user taking the photograph. Once the photo or image is taken by the user, the system can then attempt to, again, identify the element. If the element is still unrecognized, the system may provide the user with various options as shown in FIG. 5. As can be seen, the options include taking another image, marking the element as executed/recognized, reporting an issue with the system, or skipping the element.

In one variant, the user is provided with an image of the unrecognized element as an overlay over the image to be taken. The user can then align the overlay of the unrecognized element with the element in the fixture to ensure that that image is suitable/useful. The resulting image should be easier to recognize/use in the image recognition process as an aligned image should be clearer and less subject to jitter/lack of clarity. Once a dedicated image has been obtained from the user for an unrecognized element, the image recognition process is applied to the dedicated image. If the element is still unrecognized, the user is provided with the different options and the user may simply override the system or declare an error.

Once a confirmation user has finished with the confirmation of a configuration of a tangible display fixture, the results of the comparison (and whatever edits the confirmation user may have inserted into the result) as well as the expected configuration and the image from the user are saved in the database. An administrative user can then be presented with these various results and images. The administrative user can then confirm/override/replace the results as performed by the confirmation user.

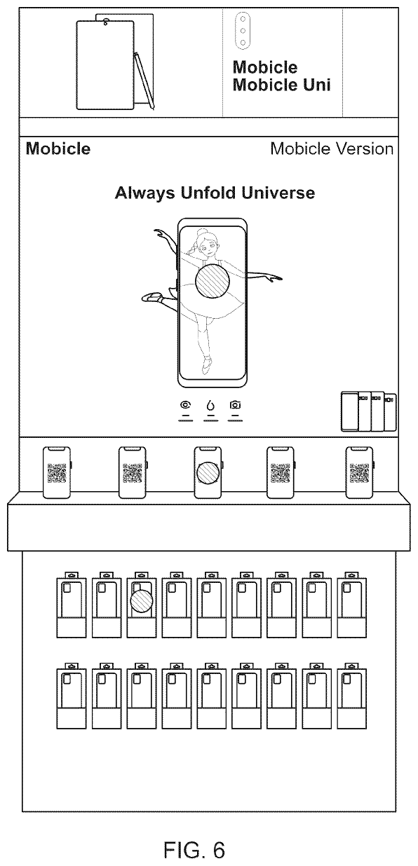

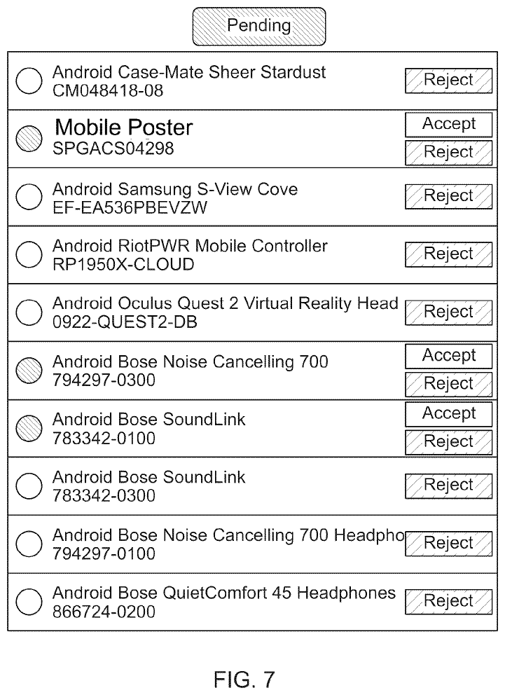

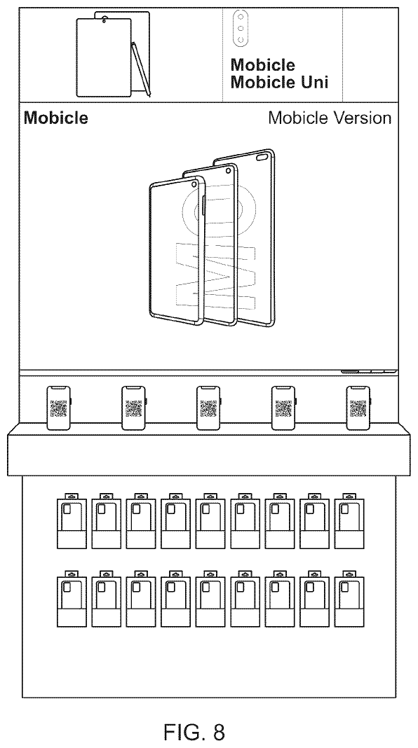

As an example of the above, FIG. 6, FIG. 7, and FIG. 8 can be presented to the administrative user. FIG. 6 illustrates a rendering of an expected configuration of a tangible display fixture and the elements where the confirmation user has overridden the system are marked with a dot (a striped dot in one version of the image). FIG. 7 is a listing of expected elements in the configured tangible display fixture—as with FIG. 6, the overrides are denoted with a striped dot. FIG. 8 is the image received from the confirmation user of the fixture at the location. As can be seen, the middle display (denoted by the striped dot in FIG. 6) is different between FIG. 6 and FIG. 8. In FIG. 7, the overrides by the confirmation user can be accepted or rejected by the administrative user. From FIG. 6 and FIG. 8, the item corresponding to this middle display should be rejected as this display (with the dancer) is clearly not in the configured fixture in FIG. 8.

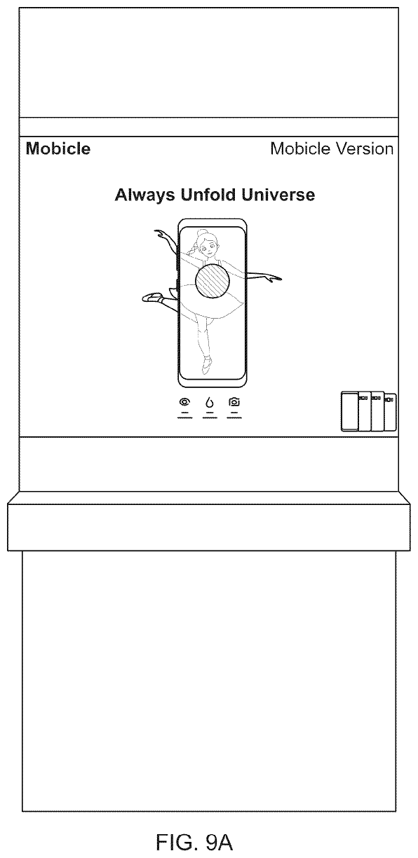

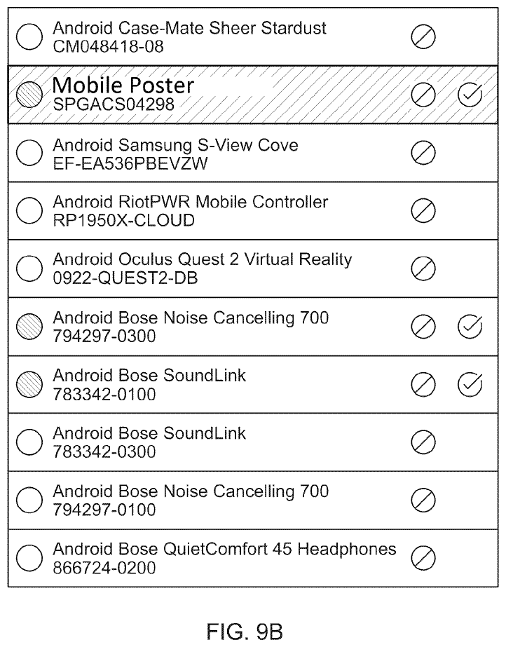

One possible feature of the system is the ability to focus on one element in the display. To continue the example shown in FIG. 6, FIG. 7, and FIG. 8, FIG. 9A is provided. As can be seen, FIG. 9A is a zoomed in view of the display that was overridden in FIG. 7 and all other elements in the fixture have been removed. FIG. 9B shows the overrides implemented by the confirming user and, as can be seen, the element corresponding to the focused element in FIG. 9A is highlighted. This allows the administrative user to select an element that was overridden and to focus on that element. This allows the administrative user to view which element, specifically, was missing/different between the expected configuration and the actual configuration. As noted above, FIG. 8 is the actual configuration while FIG. 6 is the expected configuration. Between FIG. 6 and FIG. 8, the element shown in FIG. 9A is different between these two.

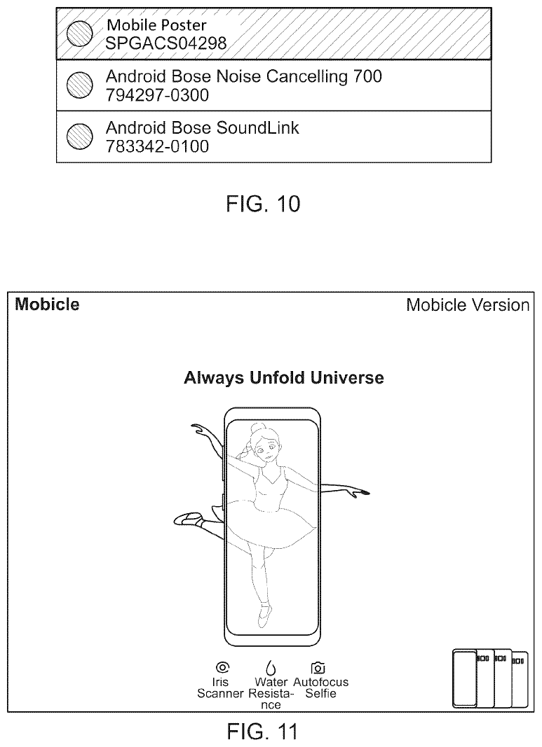

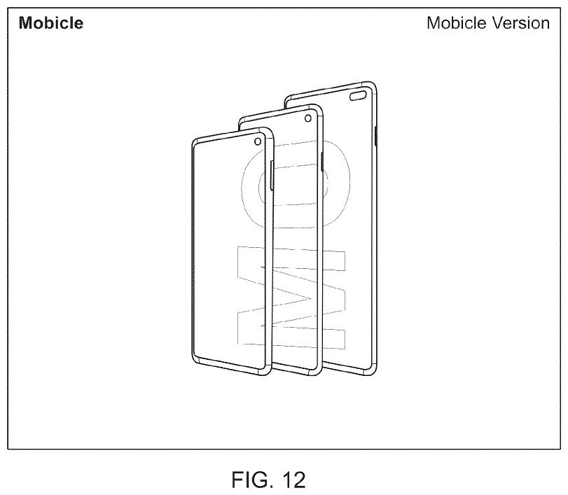

As another example of such a feature, FIG. 10, FIG. 11, and FIG. 12 are provided. FIG. 10 shows a list of missing/unverified elements in the configuration. This list is provided to the administrative user and this administrative user can select any of these missing/unverified elements. Once a missing element is selected, the system provides a view of the expected element (see FIG. 11) as well as the actual photo or image in the actual configuration as imaged/photographed by the confirmation user (see FIG. 12). This allows the administrative user to do a direct comparison between the missing/unverified element and the actual element on the actual fixture. The administrative user can then accept/reject the conclusion regarding the presence/absence of the element as determined by the confirmation user.

It should be noted that, prior to taking an image of the tangible display fixture, the system may provide the user with an image of the expected configuration of the fixture. This image of the expected configuration can take the form of an overlay that is overlaid over the user's view of the image to be taken. Such an overlay allows the user to properly align the image to be taken with the expected configuration of the fixture. Such an alignment can simplify the image recognition process as well as assist in the recognition of the various elements in the fixture and in the image.

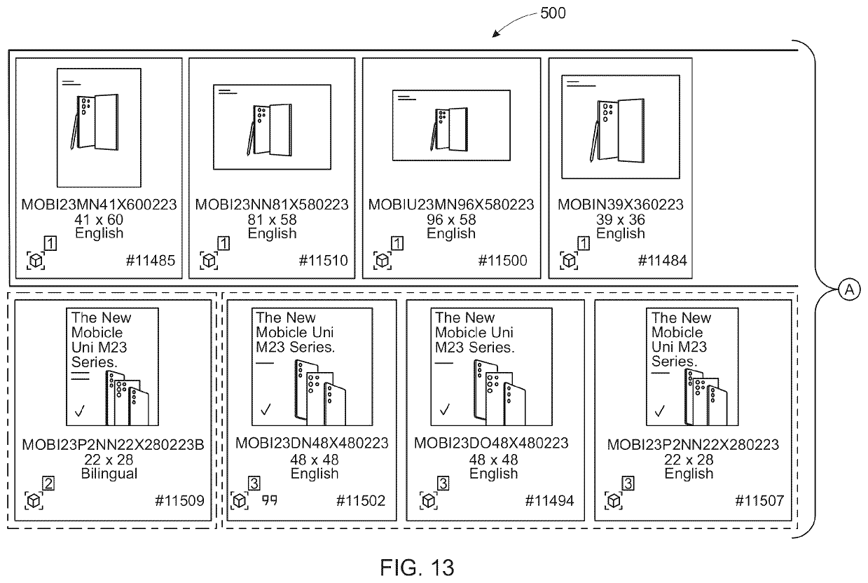

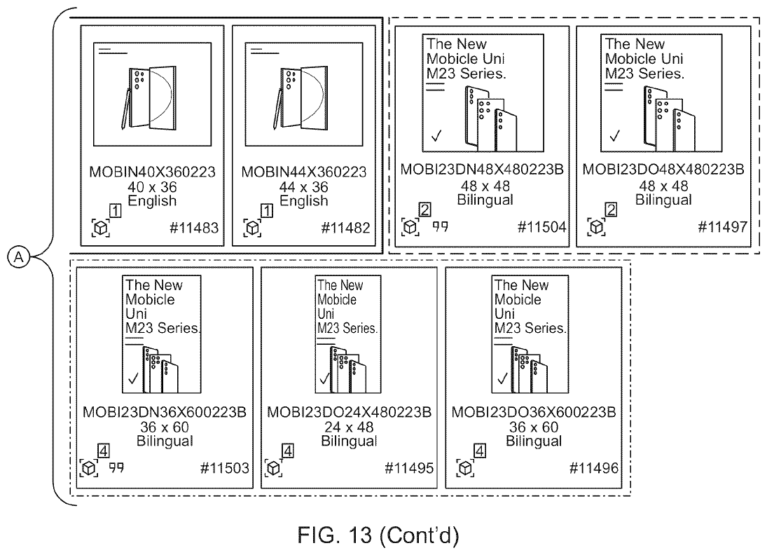

To assist the image recognition module in recognizing new or different elements that may be used in a fixture, the administrative user can upload images of elements that may be used. To ensure that the system will recognize these elements, it is preferred that the images of the elements be in different image sizes. If multiple versions/sizes of the same image are uploaded, the system would group similarly sized images together and these ad hoc groups will then be used to train the AI based image recognition process. FIG. 13 shows the resulting groupings performed by the system on multiple images uploaded by an administrative user. As can be seen, the grouping 500 consists of the same image but in different sizes. It should be clear that images that are visually and proportionally the same or similar are grouped together.

After the images of proposed elements have been uploaded, these images can then be used by the system to train its AI based image recognition module to recognize the element in the images. As can be imagined, the system can also use various AI based methods to recognize the text in the images as well as the component elements in the images. To assist in better training a machine learning model used by the AI based image recognition module, the system can also generate synthetic training sets from the images. These synthetic training sets, which can be generated by applying obfuscations, blurring, and other image altering or image changing techniques to the images, are then used to train the machine learning model used by the AI based image recognition module. This allows the trained model in the module to recognize the element even if the image received is not clear or is obfuscated or taken from various angles.

For clarity, the user device used to take the images sent to the system may be a suitable mobile device such as a smartphone. As well, the system may be implemented as a suitably configured server operating/running in the cloud and to which the smartphone can log into.

It should be clear that the various aspects of the present invention may be implemented as software modules in an overall software system. As such, the present invention may thus take the form of computer executable instructions that, when executed, implements various software modules with predefined functions.

Additionally, it should be clear that, unless otherwise specified, any references herein to ‘image’ or to ‘images’ refer to a digital image or to digital images, comprising pixels or picture cells. Likewise, any references to an ‘audio file’ or to ‘audio files’ refer to digital audio files, unless otherwise specified. ‘Video’, ‘video files’, ‘data objects’, ‘data files’ and all other such terms should be taken to mean digital files and/or data objects, unless otherwise specified.

The embodiments of the invention may be executed by a computer processor or similar device programmed in the manner of method steps, or may be executed by an electronic system which is provided with means for executing these steps. Similarly, an electronic memory means such as computer diskettes, CD-ROMs, Random Access Memory (RAM), Read Only Memory (ROM) or similar computer software storage media known in the art, may be programmed to execute such method steps. As well, electronic signals representing these method steps may also be transmitted via a communication network.

Embodiments of the invention may be implemented in any conventional computer programming language. For example, preferred embodiments may be implemented in a procedural programming language (e.g., “C” or “Go”) or an object-oriented language (e.g., “C++”, “java”, “PHP”, “PYTHON” or “C #”). Alternative embodiments of the invention may be implemented as pre-programmed hardware elements, other related components, or as a combination of hardware and software components.

Embodiments can be implemented as a computer program product for use with a computer system. Such implementations may include a series of computer instructions fixed either on a tangible medium, such as a computer readable medium (e.g., a diskette, CD-ROM, ROM, or fixed disk) or transmittable to a computer system, via a modem or other interface device, such as a communications adapter connected to a network over a medium. The medium may be either a tangible medium (e.g., optical or electrical communications lines) or a medium implemented with wireless techniques (e.g., microwave, infrared or other transmission techniques). The series of computer instructions embodies all or part of the functionality previously described herein. Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies. It is expected that such a computer program product may be distributed as a removable medium with accompanying printed or electronic documentation (e.g., shrink-wrapped software), preloaded with a computer system (e.g., on system ROM or fixed disk), or distributed from a server over a network (e.g., the Internet or World Wide Web). Of course, some embodiments of the invention may be implemented as a combination of both software (e.g., a computer program product) and hardware. Still other embodiments of the invention may be implemented as entirely hardware, or entirely software (e.g., a computer program product).

A person understanding this invention may now conceive of alternative structures and embodiments or variations of the above all of which are intended to fall within the scope of the invention as defined in the claims that follow.

We claim:

1. A system for checking a tangible display fixture for conformity with an expected configuration, the system comprising:
a checking module for receiving an image of said tangible display fixture from a user and for determining whether said tangible display fixture conforms with said expected configuration based on a comparison of elements of said image with said expected configuration;
a database for storing said image of said tangible display fixture, for storing said expected configuration of said tangible display fixture, and for storing results of said comparison of elements
a recognition module for receiving a version of said image and for recognizing one or more of said plurality of elements in said image by way of an image recognition process or by way of one or more computer readable codes contained in said image;
wherein said recognition module retrieves said expected configuration from said database and said checking module compares said expected configuration with recognized elements in said image.

2. The system according to claim 1, further comprising:
an acceptance module for presenting an administrative user with said image of said tangible display fixture and said results of said comparison of elements;
wherein said acceptance module receives input from said administrative user that either accepts said results or rejects said results.

3. The system according to claim 1, further comprising a learning module for receiving images of elements to be recognized by said system, said images of element being for use in training a machine learning model used by said image recognition process.

4. The system according to claim 1, further comprising a synthetic image module for applying image alteration techniques to one or more of said images of elements to be recognized by said system to produce synthetic images of said elements to be recognized, said synthetic images being for use in training said machine learning model.

5. The system according to claim 1, further comprising:
a segmenting module for receiving said image from said checking module and for segmenting said image into a segmented image that divides the image into a plurality of elements, said segmented image being said version of said image sent to said recognition module.

6. The system according to claim 1, wherein said recognition module produces a list of elements recognized in said version of said image and said expected configuration is a list of expected elements in said image.

7. The system according to claim 6, wherein said comparison of elements comprises comparing said list of elements recognized in said version of said image with said list of expected elements in said image.

8. The system according to claim 1, wherein said checking module provides said user with said results of said comparison.

9. The system according to claim 6, wherein, based on said list of elements recognized in said version of said image, said results produce an indication that said tangible display fixture conforms with said expected configuration when all elements in said list of expected elements are recognized in said image.

10. The system according to claim 6, wherein, based on said list of elements recognized in said version of said image, said results produce a detailing of any elements that are missing from said image but are present in said list of expected elements.

11. A method for determining if a tangible display fixture conforms with an expected configuration, the method comprising:
a) receiving an image of a configured tangible display fixture;
b) recognizing one or more elements in said image;
c) identifying said one or more elements recognized in step b);
d) retrieving identification data for said one or more elements recognized in step b);
e) comparing said one or more elements recognized in step b) with an expected configuration for said configured tangible display fixture;
f) determining whether said configured tangible display fixture conforms with said expected configuration based on results of step e);
wherein step c) is executed using an AI-based image recognition process or by way of one or more computer readable codes contained in said image.

12. The method according to claim 11, wherein step e) comprises:
producing a list of elements recognized in said image, said list of elements being for comparing with said expected configuration.

13. The method according to claim 12, wherein step c) further comprises:
comparing said list of elements recognized in said image with a list of expected elements for said expected configuration.

14. The method according to claim 12, wherein, based on said list of elements recognized in said image, said method produces an indication that said tangible display fixture conforms with said expected configuration when all elements in a list of expected elements for said expected configuration are recognized in said image.

15. The method according to claim 12, wherein, based on said list of elements recognized in said image, said method produces a detailing of any elements that are missing from said image but are present in a list of expected elements for said expected configuration.

16. The method according to claim 11, further comprising:
presenting an administrative user with said image of said tangible display fixture and results of a comparison of elements in said image with said expected configuration;
receiving input from said administrative user, said input being for either accepting said results or rejecting said results.

17. The method according to claim 11, further comprising:
receiving images of elements to be recognized by a system implementing said method;
training a machine learning model using said images of elements such that said machine learning model recognizes said elements in said images of elements.

18. The method according to claim 17, further comprising:
applying image alteration techniques to one or more of said images of elements to thereby produce synthetic images of said elements in said images of elements; and
training said machine learning model using said synthetic images.

19. The method according to claim 11, wherein, prior to step b), a segmenting step is executed, said segmenting step comprising:
segmenting said image into a segmented image that divides said image into a plurality of elements.
